(19) United States
(12) Patent Application Publication
(10) Pub. No.: US 2006/0146944 A1
(43) Pub. Date: Jul. 6, 2006

(54) System and method of processing frequency-diversity signals with reduced-sampling-rate receiver

(75) Inventor: Mao-Ching Chiu, Minxiong Shiang (TW)

Correspondence Address: TROXELL LAW OFFICE PLLC, SUITE 1404, 5205 LEESBURG PIKE, FALLS CHURCH, VA, 22041, US

(73) Assignee: Integrated Programmable Communications, Inc.

(21) Appl. No.: 11/028,591

(22) Filed: Jan. 5, 2005

(51) Int. Cl. H04K 1/10

(52) U.S. Cl. 375/260

(57) ABSTRACT

A system and method of frequency-diversity OFDM with a sampling rate less than the Nyquist rate for ultra-wideband devices are described. The channel encoder is used to encode at least one input data stream to a plurality of codewords. The evaluation device coupled to the channel encoder and having a plurality of weighting coefficients are combined with the codewords to generate a plurality of matrix elements. One or more first transformation device coupled to the evaluation device convert the matrix elements into a plurality of OFDM symbols. In addition, a modulated device coupled to the first transformation device is able to modulate the OFDM symbols to expand a plurality of different frequency bands and form a received signal. The signal filter coupled to the modulated device for eliminating noise in the received signal. More importantly, the sampling device coupled to the signal filter sample the received signal by a sampling rate less than the Nyquist rate.

### FIELD OF THE INVENTION

The present invention generally relates to a system and method of processing frequency-diversity signals, and more particularly, to a system and method of processing frequency-diversity signals with a reduced sampling rate less than the Nyquist rate.

### BACKGROUND OF THE INVENTION

Orthogonal frequency division multiplexing (OFDM) has been adopted as the physical layer of ultra-wideband systems for high-rate, short-range personal area networking (PAN). However, there is a constraint on the maximum power spectral density for the transmitted signal in the ultra-wideband systems. Therefore, the bandwidth of the transmitted spectrum must be spread widely by a bandwidth expansion scheme so that the power density of the transmitted spectrum can be kept as low as possible.

In the prior art, a problem of the frequency-diversity scheme is that the receiver must sample the base-band received signal using high-sampling-rate analog-to-digital converters (ADC) for discrete signal processing (DSP). However, such high-sampling-rate ADCs and DSP are expensive and have high power consumption due to their high operation frequency. In addition, the digital signal processing following the ADCs operates in an extremely high frequency, especially for ultra-wideband systems, where the signal may be expanded over several GHz.

Ultra-wideband systems have been recently used in high-rate, short-range personal area networking, and several efforts are still under way to adopt the UWB technology as the physical layer. According to Federal Communications Commission (FCC) regulations, the transmitted power spectral density of an UWB system should be less than −41.3 dBm/Mhz. Therefore, a bandwidth expansion scheme must be employed so that the transmitted spectrum can be spread widely in order to reduce the magnitude of the power spectral density.

Conventionally, OFDM combined with frequency hopping is a bandwidth expansion scheme for UWB. The frequency hopping scheme in the prior art hops to a different frequency band for each OFDM symbol during a data packet transmission, and such a mechanism is called multi-band OFDM (MB-OFDM). However, the MB-OFDM requires accurate and fast frequency synthesizing scheme for base-band signal recovery. In addition, the instantaneous power spectral density fluctuates due to the frequency hopping scheme, and hence exceeds the spectrum mask specified by FCC. This instantaneous fluctuation of the power spectral density has raised a great controversy over the question of whether MB-OFDM conforms with FCC regulations.

Consequently, there is a need to develop a system and method of processing frequency-diversity signals with a reduced sampling rate less than the Nyquist rate.

### SUMMARY OF THE INVENTION

One object of the present invention is to provide a system and method of processing frequency-diversity signals with a reduced sampling rate less than the Nyquist rate to solve the problem of maximum power spectral density in the ultra-wideband systems.

Another object of the present invention is to provide a system and method of processing frequency-diversity signals with a reduced sampling rate less than the Nyquist rate to reduce the sampling rate of the ADCs and DSP.

According to the above objects, the present invention sets forth a system and method of processing frequency-diversity OFDM signals with a reduced sampling rate less than the Nyquist rate. A frequency-diversity system is shown.

The frequency-diversity system comprises a channel encoder, at least one evaluation device, one or more first transformation device, a modulated device, a sampling device, a signal filter, and a sampling device. The channel encoder is used to encode at least one input data stream to a plurality of codewords. The evaluation device coupled to the channel encoder and having a plurality of weighting coefficients are combined with the codewords to generate a plurality of matrix elements. One or more first transformation device coupled to the evaluation device convert the matrix elements into a plurality of OFDM symbols. In addition, a modulated device coupled to the first transformation device is able to modulate the OFDM symbols to expand a plurality of different frequency bands and form a received signal. The signal filter coupled to the modulated device for eliminating noise in the received signal. More importantly, the sampling device coupled to the signal filter sample the received signal by a sampling rate less than the Nyquist rate. The Nyquist rate is generally defined that the sampling rate must be at least twice the signal bandwidth.

The merits of the present invention are: (a) the receiver has better performance than the FH technology, (b) the received signal has more static spectrum characteristics than the FH technology, and (c) the system requires only simple frequency synthesizing scheme for baseband signal recovery.

### BRIEF DESCRIPTION OF THE DRAWINGS

The foregoing aspects and many of the attendant advantages of this invention will become more readily appreciated as the same becomes better understood by reference to the following detailed description when taken in conjunction with the accompanying drawings, wherein:

FIG. 1 is a system block diagram of processing frequency-diversity signals with a reduced sampling rate according to the present invention;

FIG. 2 is a flow chart of processing frequency-diversity signals in FIG. 1 according to the present invention; and

FIG. 3 is the packet error rates for the data rate of 480 Mbps according to one embodiment of the present invention.

### DETAILED DESCRIPTION OF THE PREFERRED EMBODIMENTS

In the present invention, a novel bandwidth expansion scheme is provided for UWB with OFDM modulation. The bandwidth expansion is simply achieved by a frequency-diversity scheme. The frequency-diversity OFDM expands the transmission bandwidth to Mt times larger than the original transmission bandwidth, where Mt is a positive integer greater than one. An important feature of the proposed frequency-diversity scheme is that it allows the receiver to sample and process the base-band received signal with a sampling rate less than the Nyquist rate.

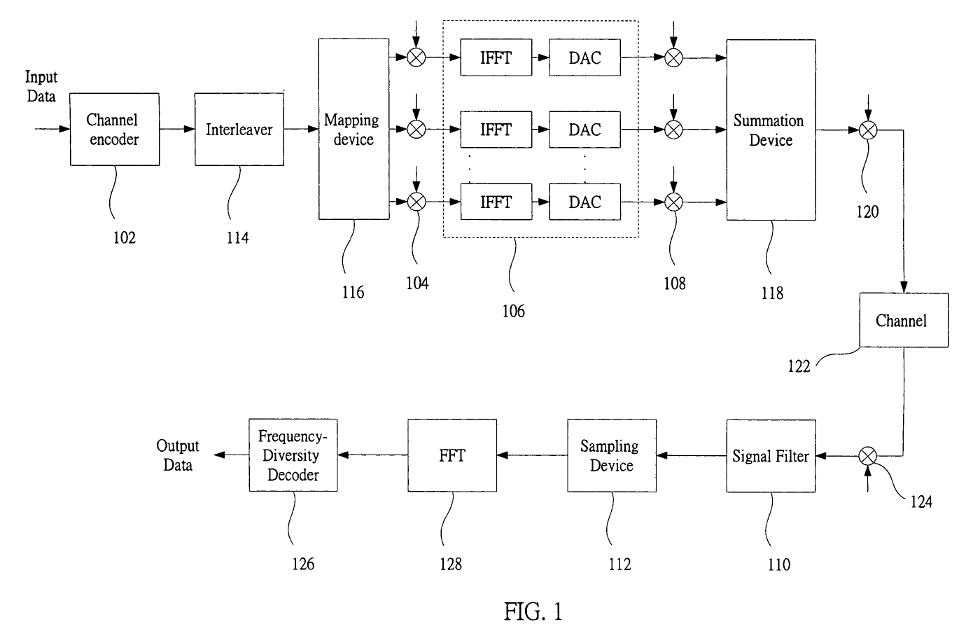

Referring to FIG. 1, a frequency-diversity system 100 is shown. The frequency-diversity system 100 comprises a channel encoder 102, at least one evaluation device 104, one or more first transformation device 106, a modulated device 108, a signal filter 110, and a sampling device 112.

The channel encoder 102 is used to encode at least one input data stream to a plurality of codewords. The evaluation device 104 coupled to the channel encoder 102 and having a plurality of weighting coefficients are combined with the codewords to generate a plurality of matrix elements. One or more first transformation device 106 coupled to the evaluation device convert the matrix elements into a plurality of OFDM symbols. In addition, a modulated device 108 coupled to the first transformation device 106 is able to modulate the OFDM symbols to expand a plurality of different frequency bands and form a received signal. At the receiver, the signal filter 110 coupled to the modulated device 108 for eliminating noise in the received signal. More importantly, the sampling device 112 coupled to the signal filter 110 samples the received signal by a sampling rate less than the Nyquist rate. The Nyquist rate is generally defined that in order to have enough information in the sample pool to reconstruct the original signal, the sampling rate must be at least twice the signal bandwidth.

In one embodiment of the present invention, the frequency-diversity system 100 further comprises an interleaver 114, a mapping device 116, a summation device 118, an up-converted device 120, a channel 122, a down-converted device 124, and a frequency-diversity decoder 126. Specifically, the interleaver 114 coupled to the channel encoder 102 and the evaluation device 104 can permute the codewords. The mapping device 116 coupled to the interleaver 114 and the evaluation device 104 for mapping the codewords. Additionally, a summation device 118 coupled to the first transformation device 106 and the modulated device 108, respectively superposes the frequency bands corresponding to the OFDM symbols.

Moreover, the up-converted device 120 coupled to the summation device 118 and the signal filter 110 is used to translate the received signal having the frequency bands from baseband to higher frequencies. The channel 122 coupled to the up-converted device 120 for transferring the received signal. The down-converted device 124 coupled to the channel 122 translates the received signal having the frequency bands from higher to baseband frequencies. The frequency-diversity decoder 126 coupled to the sampling device serve to interpret the received signal to decode the codewords.

In one preferred embodiment of the present invention, the signal filter 110 comprises a low-pass filter for removing the noise in the received signal. The low-pass filter comprises a bandwidth of (Mₜ×f_{d})/2, where Mₜ is the number of the frequency bands and f_{d} is the bandwidth of the OFDM symbols. Further, a second transformation device 128 coupled to the sampling device 112 may receive the signal to demodulate the received signal from the sampling device and output the demodulated signal to a frequency-diversity decoder 126. The second transformation device 128 comprises a fast Fourier transform (FFT) device. The first transformation device 106 comprises a plurality of inverse fast Fourier transform (IFFT) device, a digital-to-analog converter device, or the combination. The sampling device 112 comprises an analog-to-digital converter. The sampling rate of the sampling device is equal to the bandwidth of the OFDM symbols.

In the present invention, the evaluation device further comprises a channel gain generator (not shown) to form a plurality of channel gains of the frequency bands to weight all the subcarriers of the OFDM symbols, respectively. In a preferred embodiment of the present invention, the channel encoder 102 is preferably a Hamming encoder or any type of encoders.

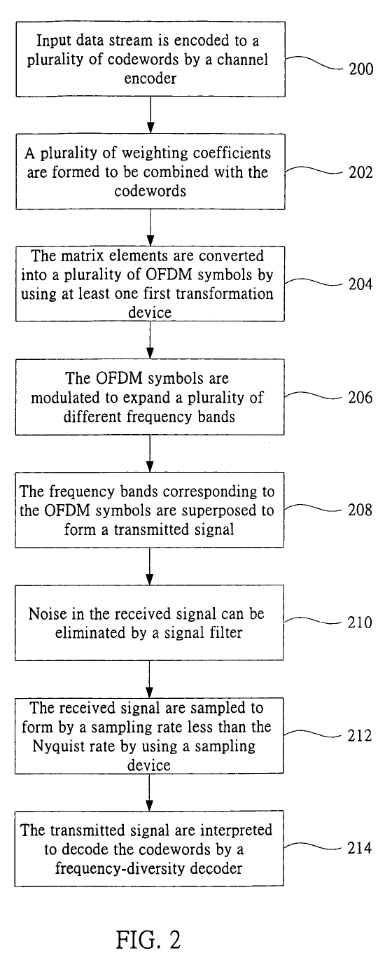

Referring to FIG. 2, a flow chart of performing a frequency-diversity system according to the present invention is shown. First, in step 200, at least one input data stream is encoded to a plurality of codewords by a channel encoder. In step 202, a plurality of weighting coefficients are formed to be combined with the codewords to generate a plurality of matrix elements by an evaluation device. Further, a plurality of channel gains of the frequency bands are formed to weight all the subcarriers of the OFDM symbols, respectively, during the step 202. In step 204, the matrix elements are converted into a plurality of OFDM symbols by using at least one first transformation device. In step 206, the OFDM symbols are modulated to expand a plurality of different frequency bands. In step 208, the frequency bands corresponding to the OFDM symbols are superposed to form a transmitted signal. In step 210, noise in the received signal can be eliminated by a signal filter. In step 212, the received signal are sampled to form by a sampling rate less than the Nyquist rate by using a sampling device. In step 214, the received signal are interpreted to decode the codewords by a frequency-diversity decoder.

The design of the frequency-diversity OFDM allows the receiver to sample with a sampling rate less than the Nyquist rate. We consider the receiver with sampling rate fₛ=f_{d}. Therefore the received signal from the kth carrier is the summation of all the kth carriers from different diversity bands. The summation of signals from different diversity bands provides diversity gain if we properly design the frequency-diversity code.

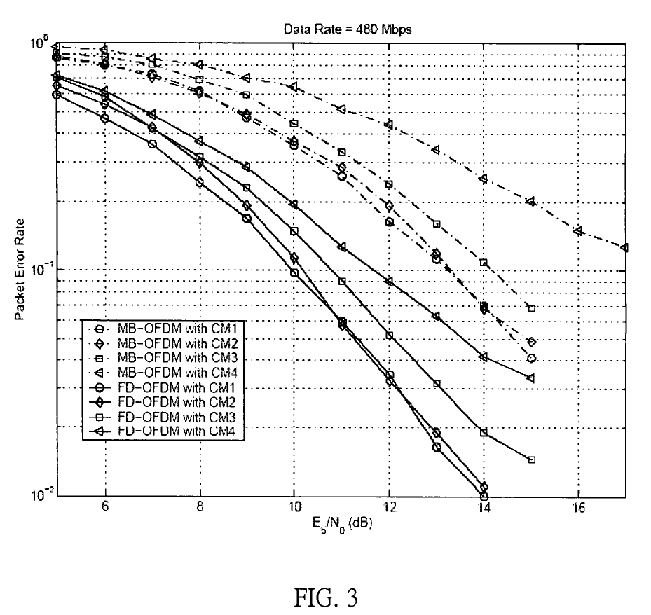

FIG. 3 shows the packet error rates for the date rate of 480 Mbps. The simulation results show that at packet error rate of 10⁻¹ the performance of FD-OFDM is at least 3 dB better than that of the MB-OFDM for channel models CM1, CM2, and CM3. For channel model CM4, the performance of FD-OFDM is at least 5 dB better than that of the MB-OFDM. In the above simulation, the packet error rate is evaluated with each packet containing 1000 bytes. At each simulation point, at least 2000 packets with different channels from the same channel model are tested. For all data rates and channel models considered, the performance of the FD-OFDM is better than that of the MB-OFDM. The performance gain is significant, especially for high data rate.

The merits of the proposed scheme are: (a) the receiver has better performance than the FH technology, (b) the received signal has more static spectrum characteristics than the FH technology, and (c) the system requires only simple frequency synthesizing scheme for baseband signal recovery. It should be noted that the channel state information is known to the transmitter. The channel state information can be obtained from the feedback channel or by leveraging the reciprocity principle in duplex transmission.

In conclusion, a novel frequency-diversity OFDM and a reduced-sampling rate receiver is provided for an ultra-wideband system in the present invention. The advantage of the proposed frequency diversity OFDM is that it allows the receiver to sample and process the received signal with a sampling rate less than the Nyquist rate. Thus, due to the reduced-sampling-rate receiver, the cost and power consumption of the receiver can be significantly reduced. Although the sampling rate is reduced, the receiver can also get significant diversity/coding gain by the design of the diversity codes.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A system of processing frequency-diversity signals with a reduced sampling rate receiver, the system comprising:
at least one evaluation device having a plurality of weighting coefficients for combining a plurality of codewords to generate a plurality of matrix elements;
at least one first transformation device coupled to the evaluation device for converting the matrix elements into a plurality of OFDM symbols;
a modulated device coupled to the first transformation device for modulating the OFDM symbols to expand a plurality of different frequency bands and form a received signal; and
a sampling device coupled to the modulated device for sampling the received signal by a sampling rate less than the Nyquist rate.

2. The system of claim 1, further comprising a channel encoder coupled to the evaluation device for encoding at least one input data stream into the codewords.

3. The system of claim 2, further comprising an interleaver coupled to the channel encoder and the evaluation device for permuting the codewords.

4. The system of claim 3, further comprising a mapping device coupled to the interleaver and the evaluation device for mapping the codewords.

5. The system of claim 1, further comprising a summation device coupled to the modulated device and the sampling device for superposing the frequency bands corresponding to the OFDM symbols, respectively.

6. The system of claim 5, further comprising:
an up-converted device coupled to the summation device for translating the received signal having the frequency bands from baseband to higher frequencies;
a channel device coupled to the up-converted device for transferring the received signal; and
a down-converted device coupled to the channel device and the sampling device for translating the received signal having the frequency bands from higher to baseband frequencies.

7. The system of claim 1, further comprising a frequency-diversity decoder coupled to the sampling device for interpreting the received signal to decode the codewords.

8. The system of claim 1, further comprising a signal filter coupled to the modulated device for eliminating noise in the received signal.

9. The system of claim 8, wherein the signal filter comprises a low-pass filter.

10. The system of claim 9, wherein a bandwidth of the low-pass filter is (Mₜ×f_{d})/2, where Mₜ is the number of the frequency bands and f_{d} is the bandwidth of the OFDM symbols.

11. The system of claim 1, further comprising a second transformation device coupled to the sampling device for demodulating the received signal from the sampling device and output the demodulated signal to a frequency-diversity decoder.

12. The system of claim 11, wherein the second transformation device comprises a fast Fourier transform (FFT) device.

13. The system of claim 1, wherein the first transformation device comprises a plurality of inverse fast Fourier transform (IFFT) device, a digital-to-analog converter device, or the combination.

14. The system of claim 1, wherein the sampling device comprises an analog-to-digital converter.

15. The system of claim 1, wherein the sampling rate of the sampling device is equal to a bandwidth of the OFDM symbols.

16. The system of claim 1, wherein the evaluation device further comprises a channel gain generator to form a plurality of channel gains corresponding to the frequency bands to weight a plurality of subcarriers of the OFDM symbols, respectively.

17. A system of processing frequency-diversity signals with a reduced sampling rate receiver, the system comprising:
a channel encoder for encoding at least one input data stream to a plurality of codewords;
at least one evaluation device coupled to the channel encoder and having a plurality of weighting coefficients for combining the codewords to generate a plurality of matrix elements;
at least one first transformation device coupled to the evaluation device for converting the matrix elements into a plurality of OFDM symbols;
a modulated device coupled to the first transformation device for modulating the OFDM symbols to expand a plurality of different frequency bands and form a received signal;
a signal filter coupled to the modulated device for eliminating noise in the received signal; and
a sampling device coupled to the signal filter for sampling the received signal by a sampling rate less than the Nyquist rate.

18. The system of claim 17, further comprising an interleaver coupled to the channel encoder and the evaluation device for permuting the codewords.

19. The system of claim 17, further comprising a summation device coupled to the modulated device and the sampling device for superposing the frequency bands corresponding to the OFDM symbols, respectively.

20. The system of claim 17, further comprising a frequency-diversity decoder coupled to the sampling device for interpreting the received signal to decode the codewords.

21. The system of claim 17, wherein the signal filter comprises a low-pass filter.

22. The system of claim 21, wherein the low-pass filter comprises a bandwidth of (Mₜ×f_{d})/2, where Mₜ is the number of the frequency bands and f_{d} is the bandwidth of the OFDM symbols.

23. The system of claim 17, further comprising a second transformation device coupled to the sampling device for demodulating the received signal from the sampling device and output the demodulated signal to a frequency-diversity decoder.

24. The system of claim 17, wherein the sampling rate of the sampling device is equal to the bandwidth of the OFDM symbols.

25. The system of claim 17, wherein the evaluation device further comprises a channel gain generator to form a plurality of channel gains corresponding to the frequency bands to weight a plurality of subcarriers of the OFDM symbols, respectively.

26. A method of processing frequency-diversity signals with a reduced sampling rate receiver, the method comprising the steps of:
generating a plurality of weighting coefficients for combining a plurality of codewords to form a plurality of matrix elements by an evaluation device;
converting the matrix elements into a plurality of OFDM symbols by using at least one first transformation device;
modulating the OFDM symbols to expand a plurality of different frequency bands to form a received signal;
sampling the received signal by using a sampling device according to a sampling rate less than the Nyquist rate.

27. The method of claim 26, further comprising a step of encoding at least one input data stream to the codewords before the step of generating a plurality of weighting coefficients.

28. The method of claim 26, further comprising a step of superposing the frequency bands corresponding to the OFDM symbols to form the received signal after the step of modulating the OFDM symbols.

29. The method of claim 28, further comprising a step of translating the received signal of the frequency bands from baseband to higher frequencies after the step of superposing the frequency bands corresponding to the OFDM symbols.

30. The method of claim 26, further comprising a step of translating the received signal of the frequency bands from higher to baseband frequencies before the step of sampling the received signal.

31. The method of claim 26, further comprising a step of eliminating noise at the receiver before the step of sampling the received signal.

32. The method of claim 26, wherein the sampling rate is equal to the bandwidth of the OFDM symbols during the step of sampling the received signal.

33. The method of claim 26, wherein the received signal comprises a bandwidth of (Mₜ×f_{d})/2, where Mₜ is the number of the frequency bands and f_{d} is the bandwidth of the OFDM symbols.

34. The method of claim 26, further comprising forming a plurality of channel gains of the frequency bands to weight a plurality of subcarriers of the OFDM symbols, respectively, during the step of generating a plurality of weighting coefficients.

35. The method of claim 26, further comprising a step of interpreting the received signal to decode the codewords by a frequency-diversity decoder after the step of sampling the received signal.
